(19) United States
(12) Patent Application Publication
(10) Pub. No.: US 2024/0367492 A1
(43) Pub. Date: Nov. 7, 2024

(54) My Sundisk

(71) Applicant: Ardeshir AVAZPOUR, Santa Clarita, CA (US)

(72) Inventor: Ardeshir AVAZPOUR, Santa Clarita, CA (US)

(21) Appl. No.: 18/445,171

(22) Filed: May 5, 2023

(51) Int. Cl. B60J 3/02

(52) U.S. Cl. CPC B60J 3/0208

(57) ABSTRACT

To enhance a long driving experience during sunny days, an extension of the automobile's factory installed visor that can be moved back and forth on the window to block the glare of the sun from hitting the neck and the side of the face, while maintaining a safe partial view.

A movable automobile accessory that provides an extension of shade needed for undisturbed travel.

A disk that can roll along as needed to change shading with alternating sized holes on the edges that work with the rubber seal of the door providing a good grip. The tiny holes throughout My Sundisk with a diameter depth ratio of 1:3 or 1:4, block the sun at the high irritating angle without obstructing view.

### BACKGROUND OF THE INVENTION

I was disturbed by the sun's burning and blinding effect while I was driving. I was irritated by the lack of coverage by the factory installed visors. I felt that more coverage was needed as a safety and comfort measure. I began developing options and came up with different prototypes that both filtered and blocked the sun while ensuring a partial view.

### BRIEF SUMMARY OF INVENTION

To solve the problem of the irritating glares, I came up with “My Sundisk”.

My Sundisk is a revolutionary driving accessory with strategic tiny holes with a diameter to depth ration of 1:3 and 1:4 that blocks the sun's blinding rays at the higher intense angels while preserving partial view.

The disk can be placed and suspended on the window between the rubber seal and the body of the automobiles body and is easily moved or rolled along as needed.

### A DETAILED DESCRIPTION OF INVENTION

A disk or sheet of material that can be slid between the rubber seal and the doors body of the automobile, specifically to block the sun blinding rays, as a movable extension of the visor.

A plastic disk of 25 cm diameter with 1 mm holes throughout the center with a diameter to depth ratio of 1:3 or 1:4, which function is to ensure that the sunlight at higher angles won't pass through, providing shade without obstruction of view.

The tapered rim of 2 cm at the edge has specially designed alternating holes of 3 mm and 6 mm with a 7 mm gap between that provides better grip while suspended at the window between the door's rubber seal and body of the automobile. The rounded and raised edges of the outside rim provides a better grip necessary for additional stability while held between the door seal and the body of the automobile.

Any surface or digital panel that can be placed between the door rubber seal of the window and the body of the automobile that can be used expressing moods, design, and advertising, that acts as a movable visor blocking the suns rays.

### A BRIEF DESCRIPTION OF DRAWINGS

FIG. 1 Side view

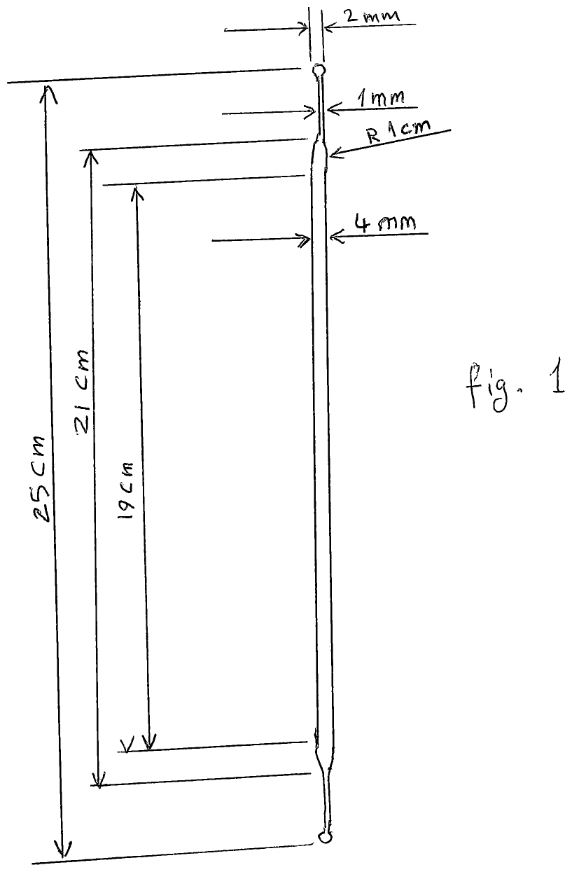

With rounded and raised edges of the outside rim, the disk stays tight in between car door rubber seal and the frame

FIG. 2 Front view

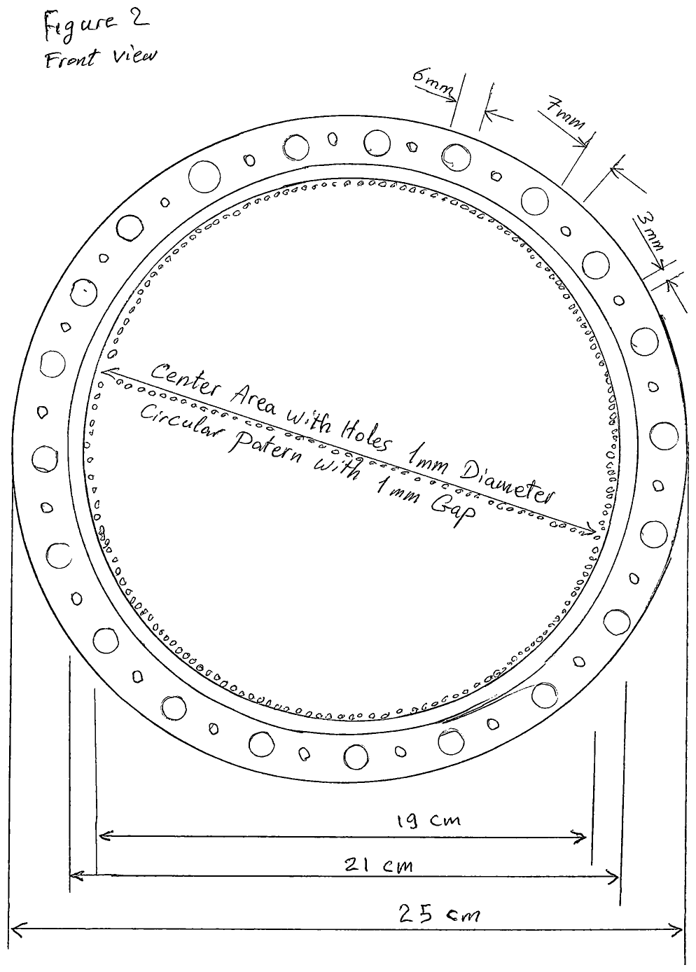

A plastic disk of 25 cm diameter with 1 mm holes throughout the center with a diameter to depth ratio of 1:3 or 1:4.

The tapered rim of 2 cm at the edge has specially designed alternating holes of 3 mm and 6 mm with a 7 mm gap between.

I claim:

I. A disk or sheet of material that can be slid between the rubber seal and the doors body of the automobile, specifically to block the sun blinding rays, as a movable extension of the visor.

II. A plastic disk of 25 cm diameter with 1 mm holes throughout the center with a diameter to depth ratio of 1:3 or 1:4, which function is to ensure that the sunlight at higher angles won't pass through, providing shade without obstruction of view.

III. The tapered rim of 2 cm at the edge has specially designed alternating holes of 3 mm and 6 mm with a 7 mm gap between that provides better grip while suspended at the window between the door's rubber seal and body of the automobile.

IV. The rounded and raised edges of the outside rim provides a better grip necessary for additional stability while held between the door seal and the body of the automobile.

V. Any surface or digital panel that can be placed between the door rubber seal of the window and the body of the automobile that can be used expressing moods, design, and advertising, that acts as a movable visor blocking the suns rays.
